(19) United States
(12) Patent Application Publication
(10) Pub. No.: US 2023/0158968 A1
(43) Pub. Date: May 25, 2023

(54) PUBLIC SAFETY VEHICLE

(71) Applicant: EV FLEET SERVICES LLC, Delaware, OH (US)

(72) Inventor: Zachary Ian Wilson, Delaware, OH (US)

(21) Appl. No.: 18/057,327

(22) Filed: Nov. 21, 2022

Related U.S. Application Data
(60) Provisional application No. 63/264,486, filed on Nov. 23, 2021.
(60) Provisional application No. 63/264,485, filed on Nov. 23, 2021.
(60) Provisional application No. 63/264,481, filed on Nov. 23, 2021.

(51) Int. Cl. B60R 11/02; B60R 21/02

(52) U.S. Cl. CPC B60R 11/0229; B60R 21/026

(57) ABSTRACT

A vehicle that can be modified for use in a variety of use environments and/or applications is provided. The vehicle includes a roof system includes a body and a roof system coupled to the body. The roof system includes a roof panel including a plurality of mounting points for the mounting of components and/or accessories. An interior cabin of the vehicle includes a front seating area, a rear seating area, and a cargo area. Divider panels may be secured in the vehicle to separate the front seating area, the rear seating area and the cargo area.

### CROSS-REFERENCE TO RELATED APPLICATIONS

This application claims priority to U.S. Provisional Application No. 63/264,486, filed on Nov. 23, 2021, entitled “Public Safety Vehicle,” and to U.S. Provisional Application No. 63/264,481, filed on Nov. 23, 2021, entitled “Roof System for Vehicle,” and to U.S. Provisional Application No. 63/264,485, filed on Nov. 23, 2021, entitled “Divider Panel System for Vehicle,” the disclosures of which are incorporated herein by reference in their entireties.

### FIELD

This document relates, generally, to features of a vehicle equipped for a public safety application.

### BACKGROUND

A motor vehicle typically includes a body and a roof coupled to the body. The body and the roof may define, for example, an interior cabin, an engine compartment, a cargo compartment and the like. In some situations, motor vehicles may be equipped for use in specific environments and/or for specific uses or applications. One such specific application may include a public safety application. Equipping a vehicle for use in a public safety environment and/or for use as a public safety vehicle may rely on the use of specialized components and/or accessories and/or equipment and/or physical configuration. Current vehicles lack the physical interfaces, configuration and the like to provide for the incorporation of these types of specialized components and/or accessories and/or equipment and/or physical features in the retrofit of a vehicle for use as a public safety vehicle.

### SUMMARY

In one general aspect, a vehicle includes a body defining an interior cabin including a front cabin area, a rear cabin area and a cargo area; a roof system coupled to the body, the roof system including a roof panel including a plurality of mounting points configured to provide for the mounting of auxiliary equipment to the roof panel; a first divider panel separating the rear cabin area from the front cabin area; a second divider panel separating the rear cabin area from the cargo area; and a console provided in the front cabin area, the console including one or more interface devices for controlling auxiliary equipment mounted on the vehicle or in the interior cabin.

In some implementations, the vehicle includes a rear seat installed in the rear cabin area, including a seat base having a first portion thereof coupled to a floor of the vehicle and a second portion thereof coupled to a frame portion of the vehicle; a seat back having a first portion thereof coupled to the second portion of the seat base and to the frame portion of the vehicle, and a second portion thereof coupled to a cargo area bracket system.

In some implementations, the vehicle includes at least one first coupling device and at least one second coupling device coupling the seat base to a flange extending upward from a floor portion of the rear cabin area.

In some implementations, the at least one first coupling device includes at least one fastener extending through a portion of the seat base and a corresponding portion of the flange to secure a position of the seat base relative to the floor portion; and the at least one second coupling device comprises at least one pin formed on the flange, and at least one corresponding slot formed in a corresponding portion of the seat base to guide a positioning of the seat base relative to the flange, and to maintain a lateral position of the seat base in the rear cabin area.

In some implementations, the seat base is made of a single sheet of metal material, including one or more bent portions to define a contour of the seat base.

In some implementations, the seat back is made of a single sheet of metal material, including one or more bent portions to define a contour of the seat back.

In some implementations, the vehicle includes a compartment defined between the seat base and a floor portion of the vehicle, wherein the compartment is configured to receive a battery therein.

In some implementations, the seat base and the seat back are made of an aluminum material.

In some implementations, the cargo area bracket system includes a first bracket at a first lateral side of the cargo area; and a second bracket at a second lateral side of the cargo area.

In some implementations, a first lateral end portion of the second portion of the seat back is coupled between the first bracket and a coupling portion of the second divider panel; and a second lateral end portion of the second portion of the seat back is coupled between the second bracket and the coupling portion of the second divider panel.

In some implementations, the first bracket and the second bracket each include a first flange coupled to one or more mounting points defined in a cargo frame of the cargo area; a second flange coupled to an upper end portion of the seat back and to a coupling portion of the second divider panel; and a cross member extending between the first flange and the second flange.

In some implementations, a first lateral end portion of the second portion of the seat back is positioned between the second flange of the first bracket and a coupling portion of the second divider panel, with a first fastener extending through the coupling portion of the second divider panel, the first lateral end portion of the second portion of the seat back, and the second flange of the first bracket; and a second lateral end portion of the second portion of the seat back is positioned between the second flange of the second bracket and the coupling portion of the second divider panel, with a second fastener extending through the coupling portion of the second divider panel, the second lateral end portion of the second portion of the seat back, and the second flange of the second bracket, to secure the seat back to the frame portion of the vehicle.

In some implementations, the console includes a mounting portion including a mounting configured for detachable mounting of a display device.

In some implementations, the mounting plate is oriented at an angle with respect to the console such that a display device mounted thereon is visible by a user seated in a driver's seat of the front cabin area or a user seated in a passenger's seat of the front cabin area.

In some implementations, the console includes a mounting arm configured for movable mounting of an input device such that the input device is accessible by a user seated in a driver's seat of the front cabin area or a user seated in a passenger's seat of the front cabin area.

In some implementations, the display device and the input device are operably coupled to a computing device that is remote from the console.

In some implementations, the vehicle includes at least one bumper bracket coupled to a front frame portion of the vehicle; and a push bumper positioned at a front cowling of the vehicle and coupled to the front frame portion of the vehicle by the at least one bumper bracket.

In some implementations, the push bumper includes at least one installation point for relocation of at least one optical sensor from the front cowling to the push bumper positioned at the front cowling.

The details of one or more implementations are set forth in the accompanying drawings and the description below. Other features will be apparent from the description and drawings, and from the claims.

### BRIEF DESCRIPTION OF THE DRAWINGS

FIG. 1A is a front perspective view, and FIG. 1B is a rear perspective view, of an example vehicle.

FIG. 1C is a front view of a bumper portion of the example vehicle shown in FIGS. 1A and 1B.

FIG. 1D is a perspective view of a first configuration of an example bracket system attachable to the bumper portion shown in FIG. 1C.

FIG. 1E is a perspective view of a second configuration of an example bracket system attachable to the bumper portion shown in FIG. 1C.

FIGS. 1F(1) and 1F(2) illustrate an example license plate bracket.

FIGS. 1G(1), 1G(2) and 1G(3) provide various views of the example license plate bracket shown in FIGS. 1F(1) and 1F(2).

FIG. 2A illustrates an example front seating area of the example vehicle shown in FIGS. 1A and 1B.

FIGS. 2B-2F illustrate an example console installed in the example front seating area shown in FIG. 2A.

FIG. 2G is a perspective view of an example dashboard cover assembly.

FIGS. 3A-3H(3) illustrate features of an example rear cabin area of the example vehicle shown in FIGS. 1A and 1B.

FIGS. 4A-4D illustrate features of an example cargo area of the example vehicle shown in FIGS. 1A and 1B.

FIGS. 5A(1)-5E(2) illustrate example divider panels for use in the example vehicle shown in FIGS. 1A and 1B.

FIGS. 6A-6D are additional interior views of the example vehicle.

### DETAILED DESCRIPTION

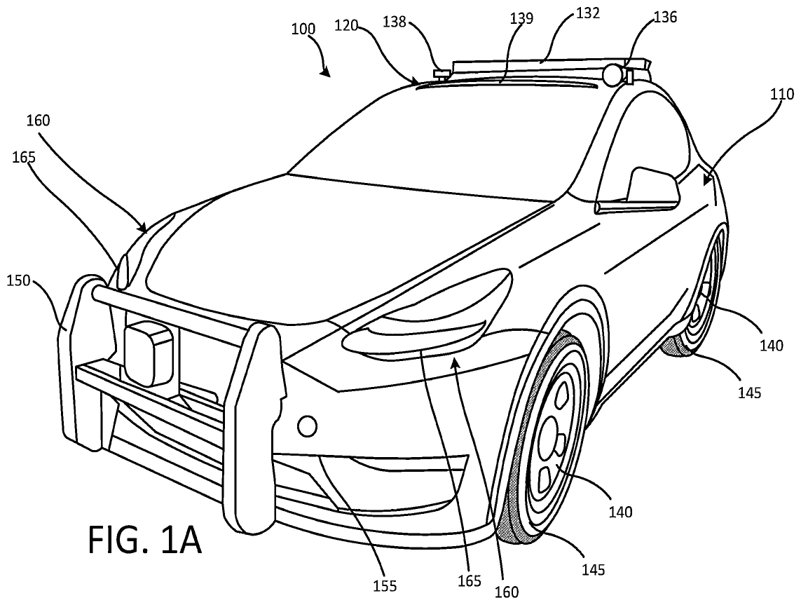

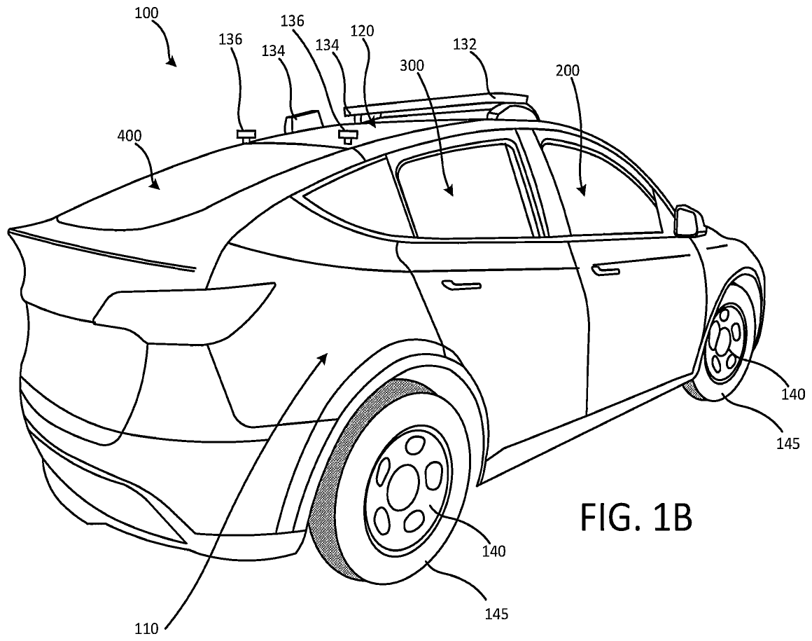

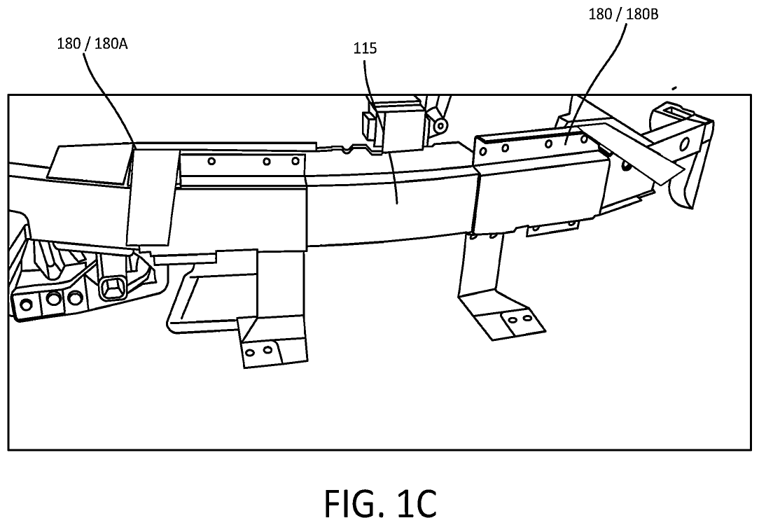

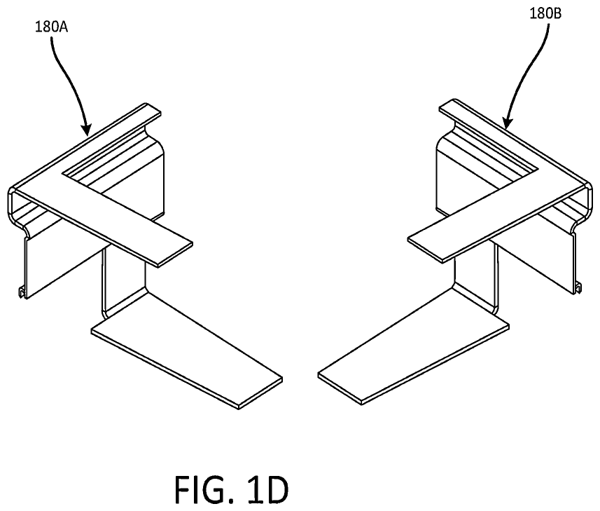

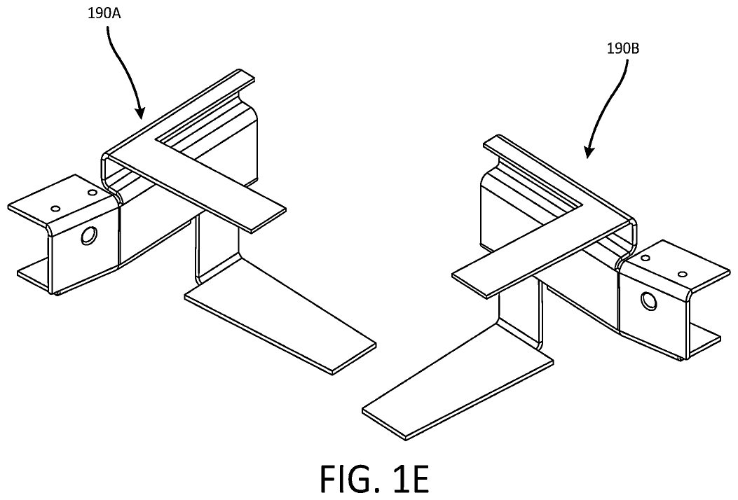

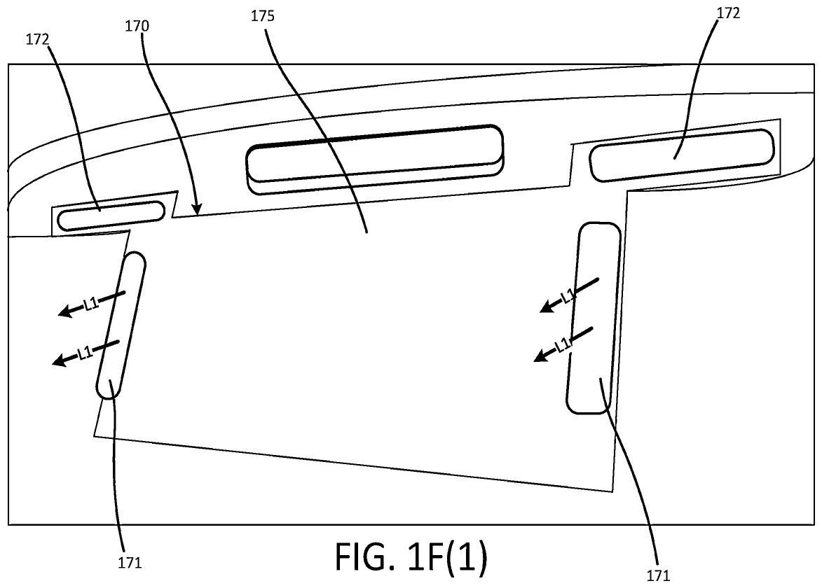

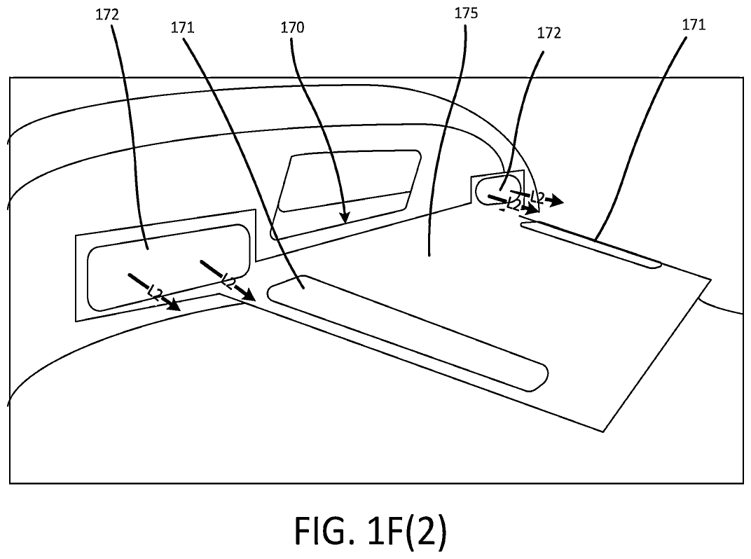

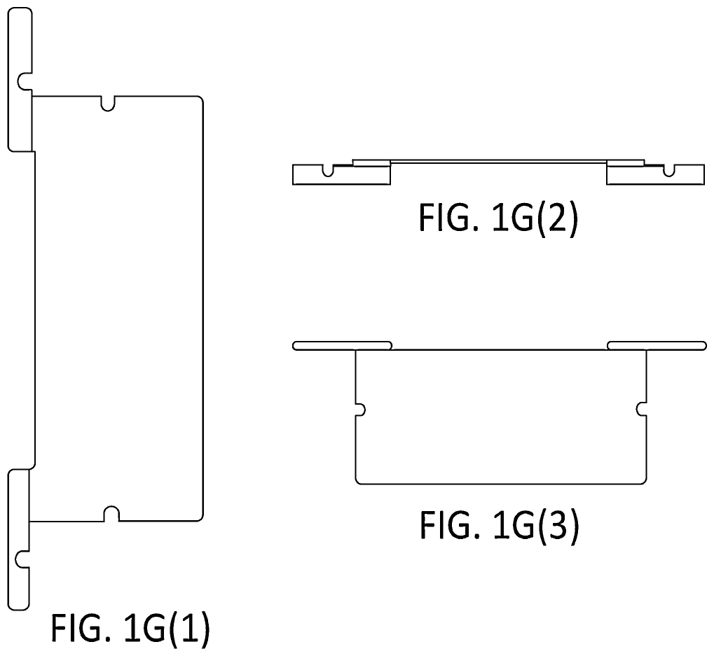

FIG. 1A is a front perspective view, and FIG. 1B is a rear perspective view, of an example vehicle 100. The example vehicle 100 shown in FIGS. 1A and 1B is equipped as a public safety vehicle and in particular as a police vehicle, simply for purposes of discussion and illustration. The principles to be described herein can be applied to the equipping of vehicles for other types of public safety applications and/or for other applications in which it is beneficial to incorporate specialized components and/or accessories and/or equipment into the vehicle for a particular application.

The example vehicle 100 shown in FIGS. 1A and 1B includes a roof system 120 coupled to a body 110 of the vehicle. The roof system 120 may be coupled to a frame portion (not shown in FIGS. 1A and 1B) of the vehicle 100, and may provide for the coupling of a plurality of different types of components and/or accessories and/or equipment to the vehicle 100. In some examples, the roof system 120 may include a plurality of mounting points that facilitate the installation and/or removal and/or replacement of components and/or accessories and/or equipment on the roof system 120. The example arrangement shown in FIGS. 1A and 1B includes an exterior light bar 132, one or more antennas 134, one or more spotlights 136, one or more cameras 138, and a visor light bar 139, mounted to the roof system 120, simply for purposes of discussion and illustration. More, or fewer, components and/or accessories may be coupled to the roof system 120 via the mounting points, in different combinations and/or locations. In some examples, the mounting points may be capped when not in use. More details related to the installation and/or removal and/or replacement of components and/or accessories and/or equipment to/from the roof system 120 via the mounting points can be found in the related U.S. application Ser. No. 18/057,307, filed on Nov. 21, 2022, entitled “Roof System for Vehicle.”

The example vehicle 100 may include wheels 140 and/or tires 145 that are configured for the particular application for which the vehicle 100 is equipped. In the example shown in FIGS. 1A and 1B, the vehicle may include wheels 140 and tires 145 that are specifically configured for use in a public safety application, and in this particular example, for use in a police vehicle. In this example, the wheels 140 may be made of a material, such as, for example steel, that is capable of withstanding the various conditions to which the vehicle 100 may be subjected while in use as a police vehicle. Similarly, the tires 145 may be configured to withstand the various conditions to which the vehicle 100 may be subjected to while in use as a police vehicle. This may include, for example, reinforced sidewalls, increased sidewall diameter, specialized tread, and other such features.

The example vehicle 100 shown in FIGS. 1A and 1B includes a push bumper 150 coupled to a front portion of the body 110 of the vehicle 100. In particular, the push bumper 150 may be coupled to a front frame portion 115 of the vehicle 100, via one or more brackets 180, as shown in FIG. 1C. In particular, FIG. 1C illustrates the front portion of the vehicle 100, with the push bumper 150 and a front cowling 155 of the body 110 removed, so that the front frame portion 115 of the vehicle 100 and the one or more brackets 180 are visible. In the example arrangement shown in FIG. 1D, two brackets 180, i.e., a first bracket 180A and a second bracket 180B, provide for the coupling of the push bumper 150 to the vehicle 100, simply for purposes of discussion and illustration. In the example shown in FIG. 1C, the first bracket 180A and the second bracket 180B are substantially symmetrically arranged about a centerline of the front frame portion 115 of the vehicle 100. FIG. 1D provides perspective views of the first bracket 180A and the second bracket 180B, removed from the front frame portion 115 of the vehicle 100. FIG. 1E provides perspective views of an alternate configuration of the brackets, including a first bracket 190A and a second bracket 190B.

In some situations, sensors, for example, optical/image sensors may be installed within the cowling 155, to collect data that provides driving and parking assistance, that increases situational awareness in the area surrounding the vehicle 100, and the like. Installation of the push bumper 150 as shown may, in some configurations, be captured within a field of view of one or more of the sensors. This may cause one or more of the sensors to inaccurately interpret the push bumper 150 as an obstacle to be avoided. The inaccurate interpretation of the push bumper 150 as an obstacle may cause the sensor(s) to output unnecessary alerts, may cause undue corrections in driving patterns, and the like. In some examples, the push bumper 150 may include installation points that provide for relocation of one or more of the sensors for which a field of view would otherwise be obscured by the installation of the push bumper 150, so that the sensors may maintain proper functionality.

In some examples, the vehicle 100 can include headlights 160 having at least a portion 165 that is configured to emit a customized lighting pattern and/or color. For example, in a vehicle that is equipped for use in a public safety application, such as a police vehicle, the portion 165 of the headlights 160 may be configured to selectively emit red and/or blue light, to emit intermittent and/or flashing patterns, and the like, based on a control signal applied to a control board of the headlights 160.

In some examples, the vehicle 100 can include a bracket 170 for attachment of a license plate to a rear portion of the vehicle 100. In an example in which a cargo area 400 of the vehicle 100 is accessed via a liftgate, opening of the liftgate may obscure roof mounted warning lights such as the exterior light bar 132 and other such warning lights. FIG. 1F(1) illustrates the bracket 170 mounted on the liftgate, with the liftgate in a closed position, such as shown in FIG. 1A. FIG. 1F(2) illustrate the bracket 170 mounted on the liftgate, with the liftgate in an open position, in which the liftgate may obscure a view of the roof mounted warning lights when approaching the vehicle from the rear. FIGS. 1G(1)-1G(3) provide various views of the example license plate bracket 170.

As shown in FIG. 1F(1), the bracket may include a plate 175 on which a license plate is to be mounted. A first pair of lights 171 may be positioned vertically (in the example orientation shown in FIG. 1F(1)) at first and second lateral sides of the plate 175. A second pair of lights 172 may be positioned horizontally, above the plate 175. In the example shown in FIG. 1F(1), the second set of lights 172 includes one of the second set of lights 172 positioned horizontally above the plate 175, to the left of the plate 175, and another of the second set of lights 172 positioned horizontally above the plate 175, the right of the plate 175. In this example, the offset positioning of the second set of lights 172 accommodates the positioning of a liftgate handle therebetween.

In the closed orientation of the liftgate shown in FIG. 1F(1), the first set of lights 171 may output light, for example in the direction of the arrows L1, to illuminate the rear portion of the vehicle 100, the license plate and the like. In this orientation, the second set of lights 172 are not visible, and are nested beneath a ledge formed in the liftgate that also accommodates the liftgate handle. In the opened orientation of the liftgate shown in FIG. 1F(2), the second set of lights 172 may output light, for example, in the direction of the arrows L2. Due to the orientation of the second set of lights 172, and the corresponding direction of the light output by the second set of lights 172, the light output by the second set of lights 172 may be when approaching from the rear of the vehicle 100, even when the open position of the liftgate obscures light output by the roof mounted lighting.

In some examples, operation of the second set of lights 172 may be automatically activated in response to a detected opening of the liftgate. In some examples, operation of the second set of lights 172 may be manually controlled, for example, via a switch provided proximate an access opening into the rear cargo area 400 of the vehicle 100. In some examples, the second set of lights may output one of more different colors of light. In some examples, the second set of lights 172 may output light in a selected pattern. In some examples, the pattern may include the output of a plurality of different colors of light. In some examples, the pattern may include a flashing pattern, including intermittent output of light. In some examples, the pattern may include a combination of and output of different colors and a flashing pattern.

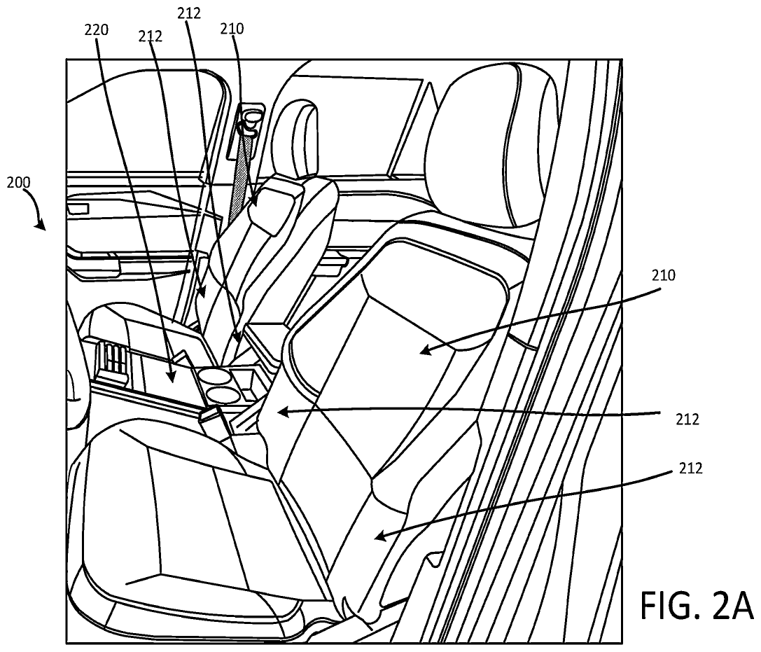

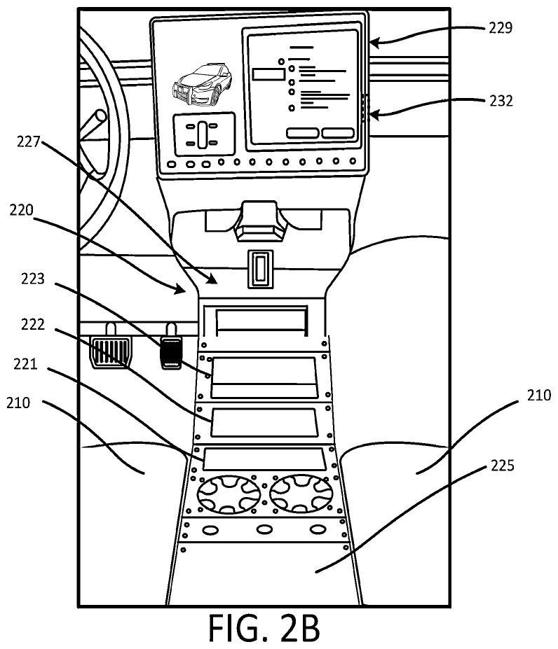

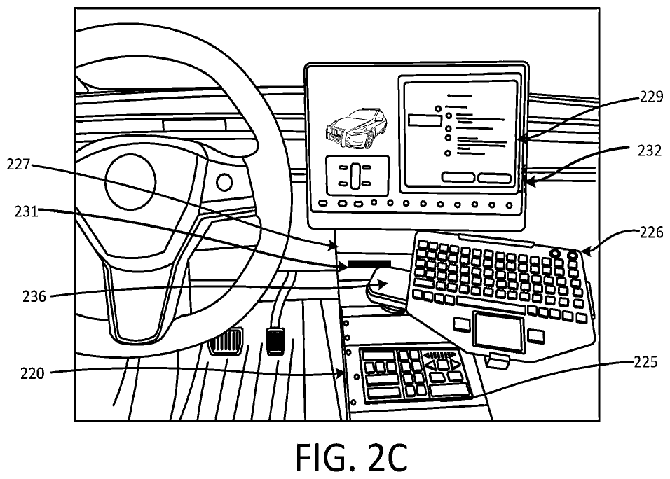

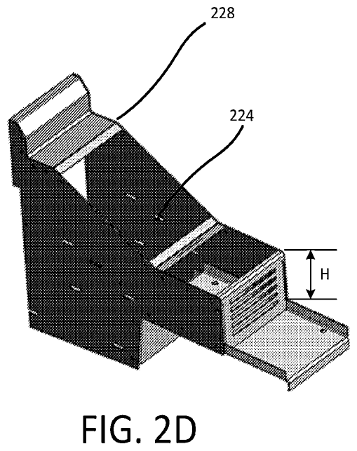

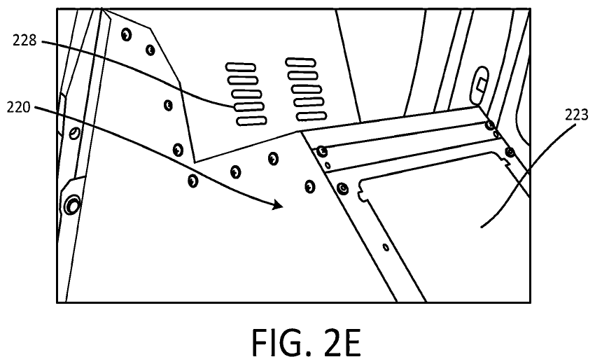

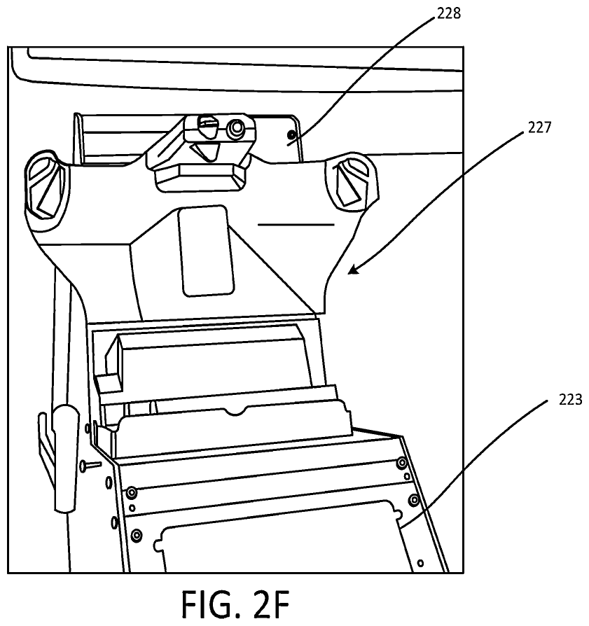

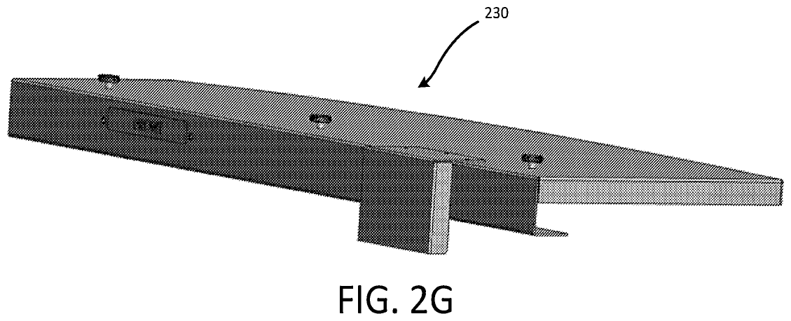

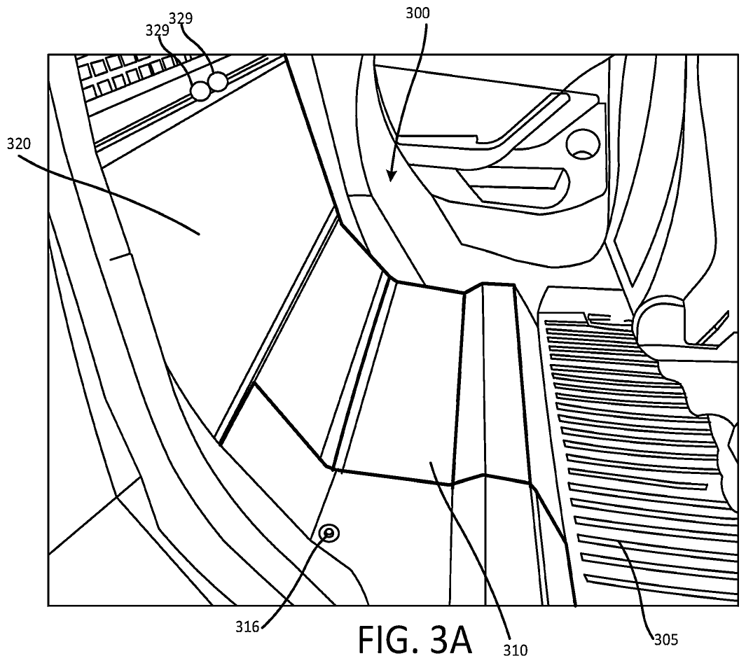

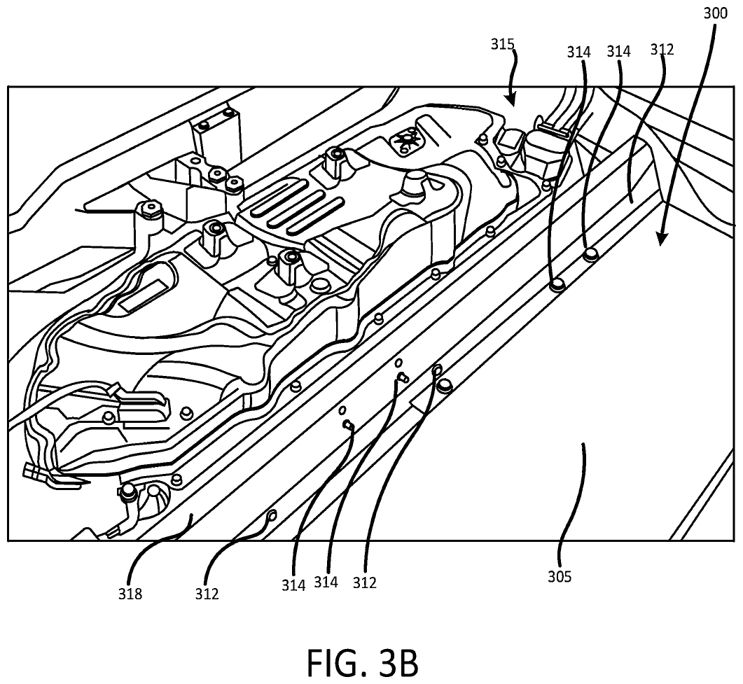

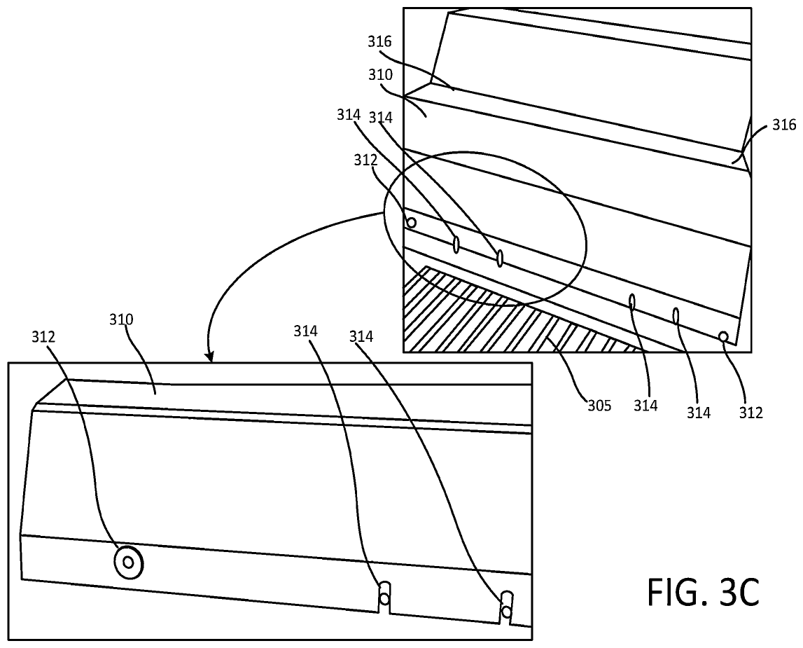

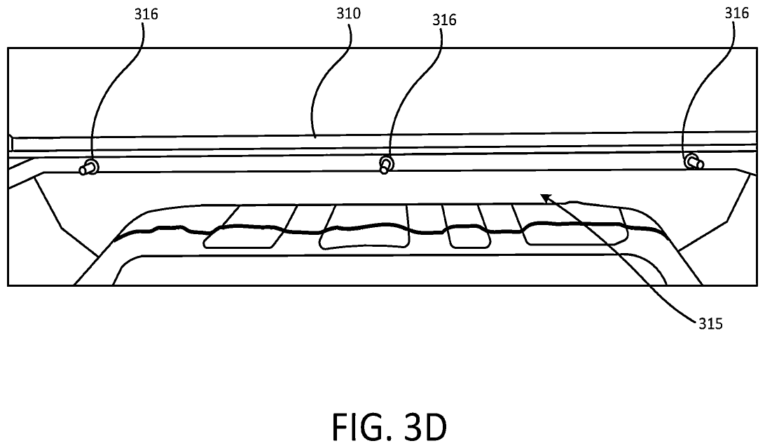

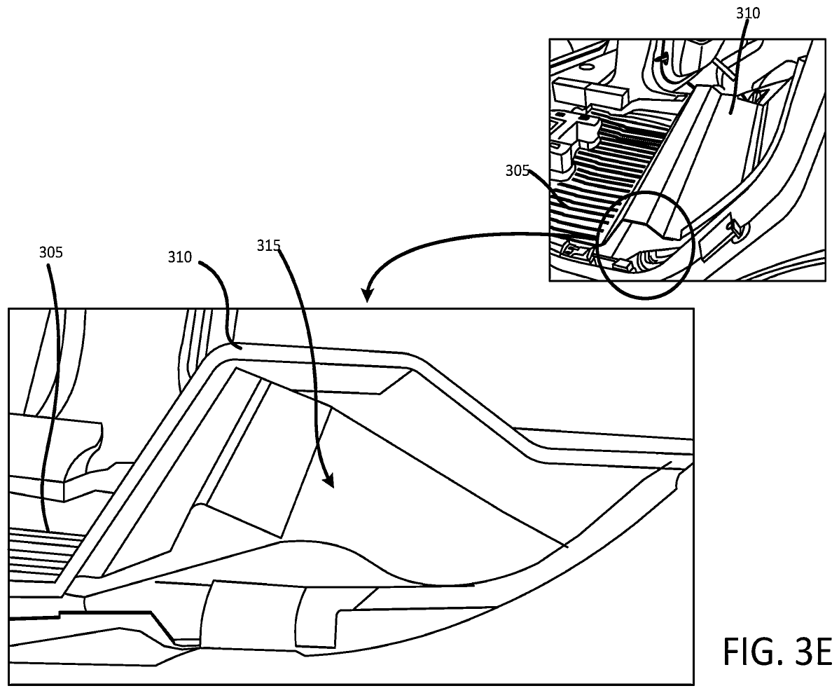

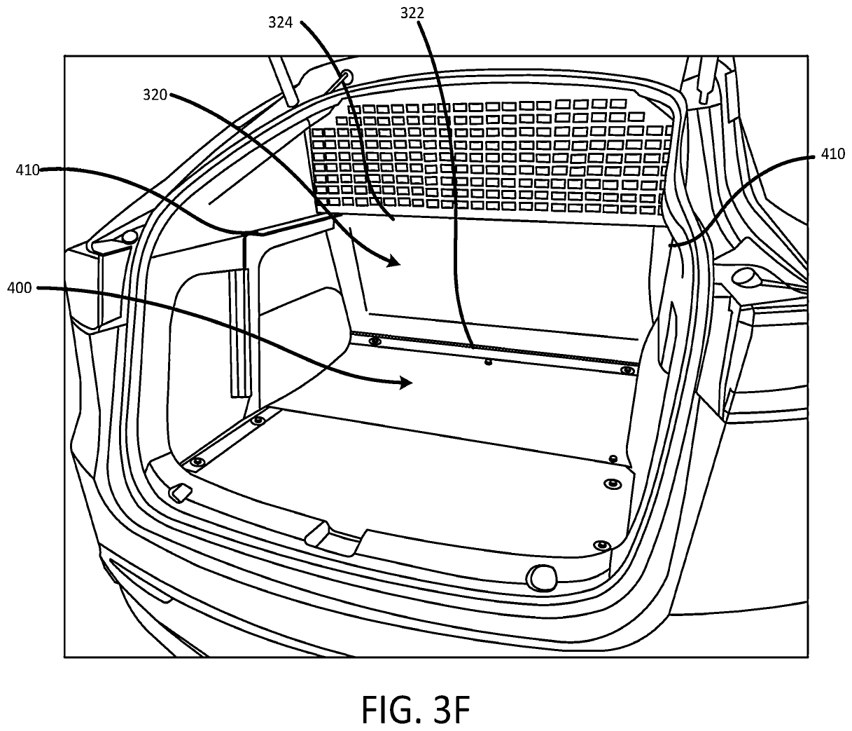

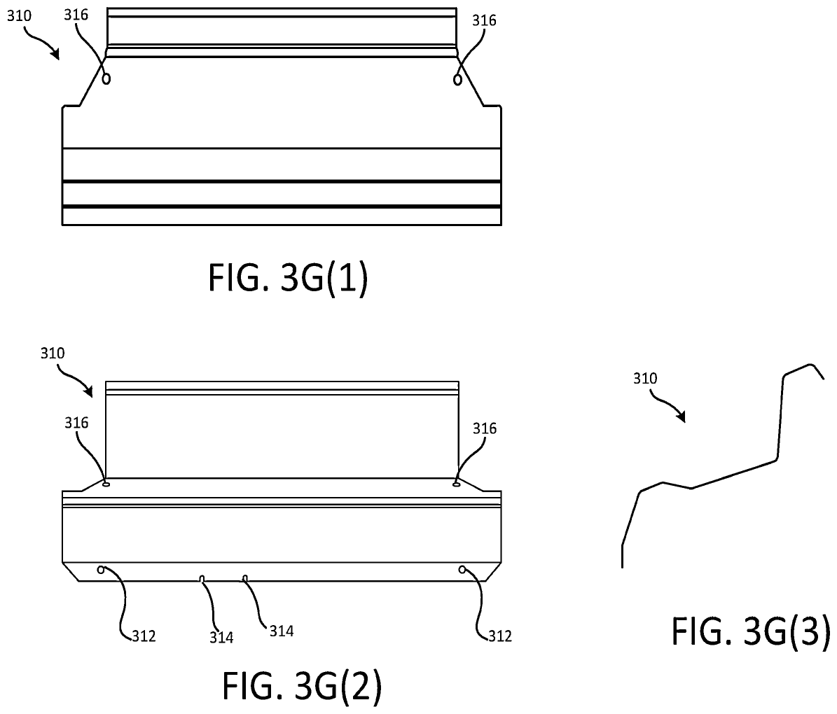

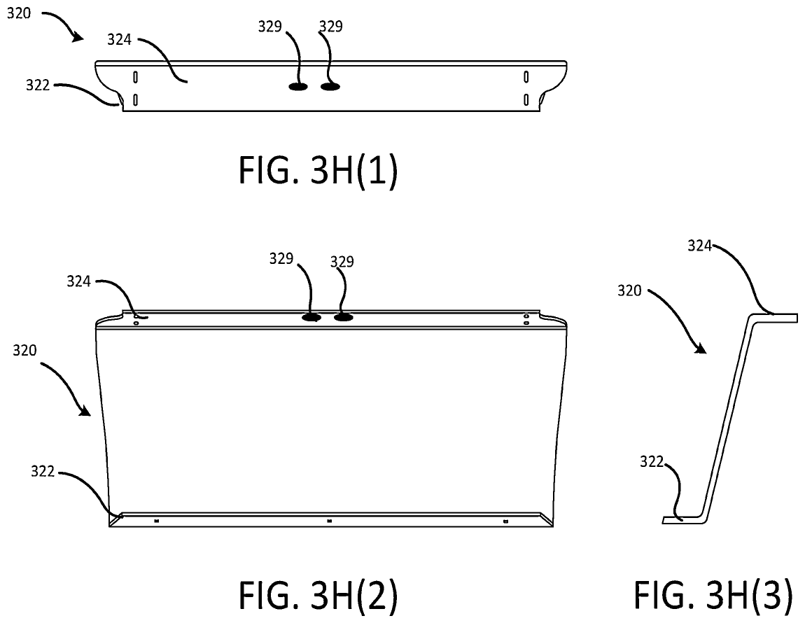

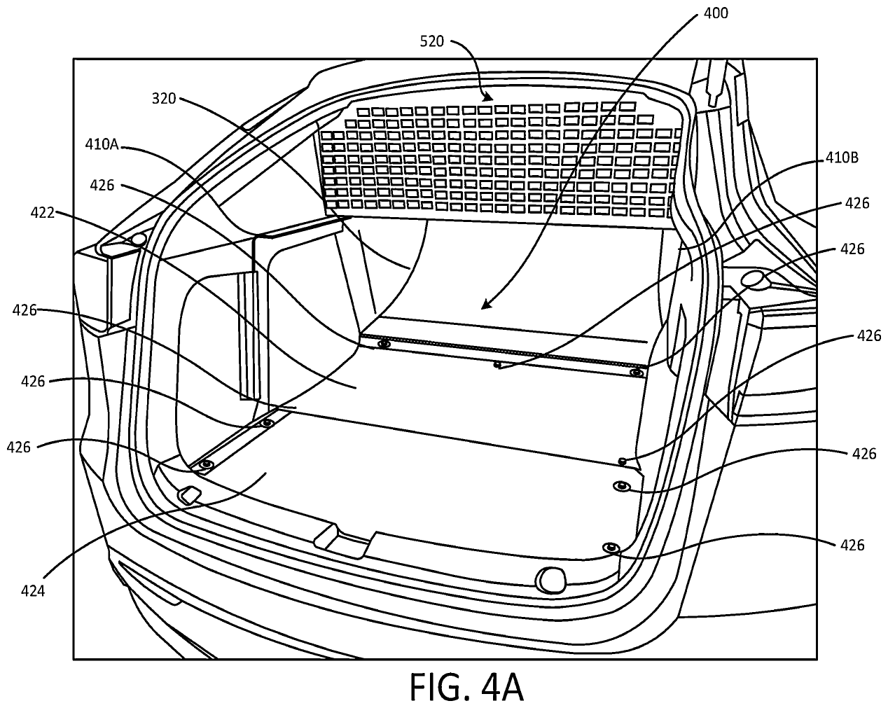

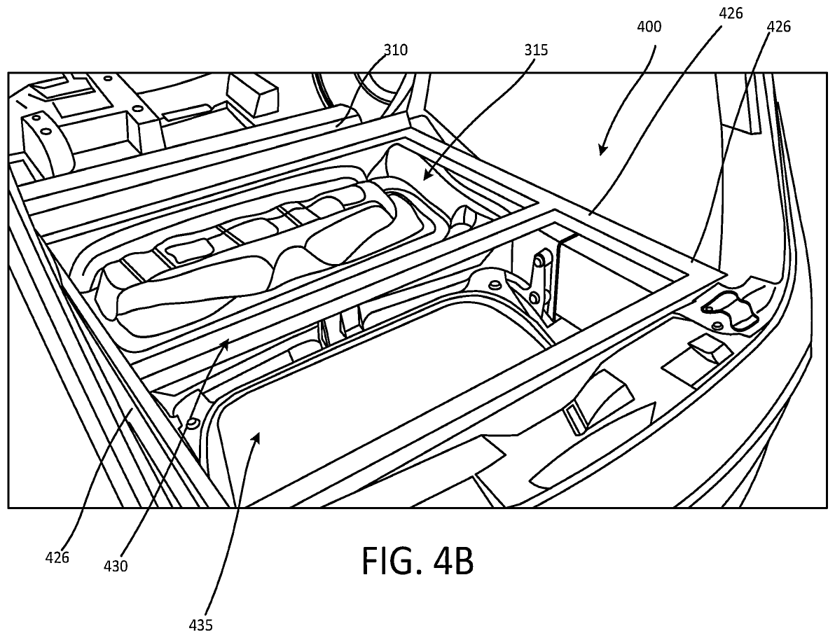

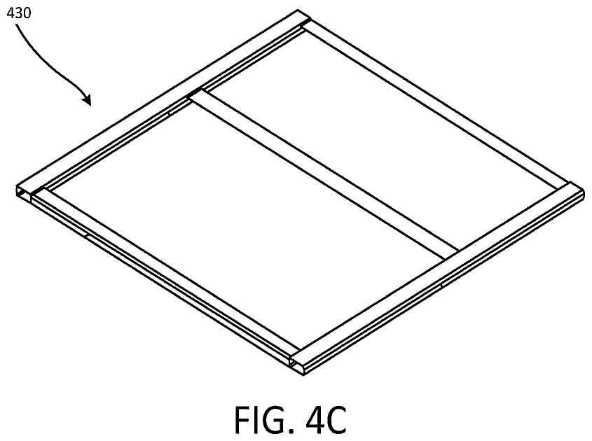

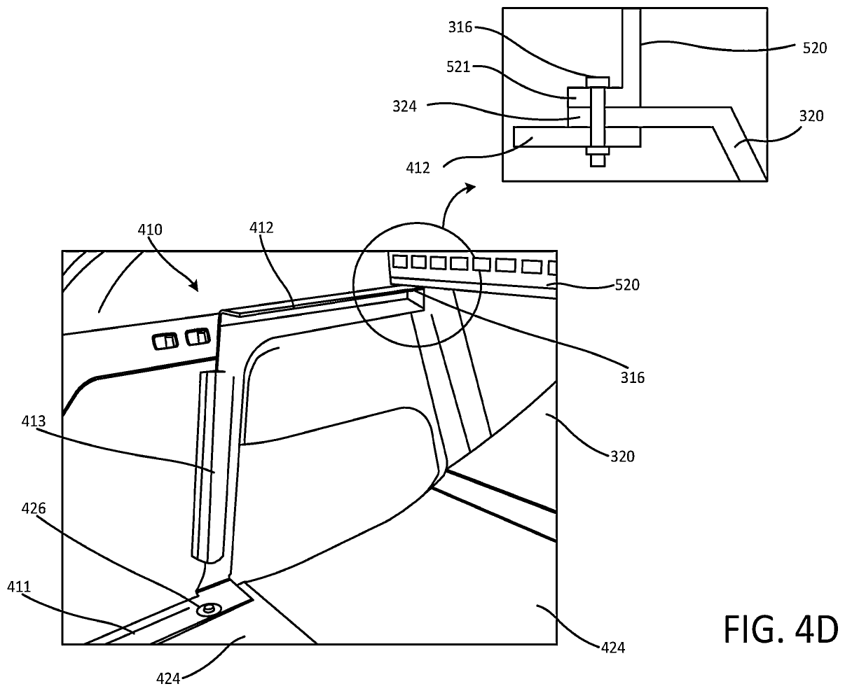

An interior cabin of the vehicle may include a front cabin area 200, a rear cabin area 300, and a cargo area 400. Example features of the front cabin area 200 are shown in FIGS. 2A-2F. Example features of the rear cabin area 300 are shown in FIGS. 3A-3H(3). Example features of the cargo area 400 are shown in FIGS. 4A-4D.

FIG. 2A is a view of the front cabin area 200 of the vehicle 100, taken from a driver side door of the vehicle 100. In the example arrangement shown in FIG. 2A, two seats 210 are installed in the front cabin area 200 (i.e., a driver's seat and a passenger's seat). A console 220 is positioned between the two seats 210. In the example shown in FIG. 2A, in which the vehicle 100 is equipped for a public safety application, each seat 210 includes side bolsters having contoured portions 212. The contoured portions 212 may be positioned at a lower end portion of the side bolsters, where a back portion approaches a seating portion of the seat 210. The contoured portion 212 of each seat 210 may be shaped or contoured to accommodate a duty belt worn by a public safety officer. The contoured portion 212 may reduce and/or eliminate interference with the duty belt and/or equipment coupled to the duty belt worn by a public safety officer. The contoured portion 212 of the side bolster allows the public safety officer to be properly and comfortably seated in the seat 210 while wearing the duty belt, without interference with the side bolsters. The contoured portion 212 of the side bolsters allows the public safety officer to enter and exit the front cabin area 200 of the vehicle 100 without interference with the duty belt worn by the public safety officer that would otherwise impede smooth egress and/or entrance.

FIGS. 2B and 2C are plans view of the console 220. FIG. 2D is a perspective view of the console 220, with a cover 225 removed so that an interior compartment 224 of the console 220 is visible. FIGS. 2E and 2F are close in views of the console 220. The compartment 224 of the example console 220 has a relatively low height H, corresponding to the contoured portions of the 212 of the seats 210, so that the console 220 does not interfere with the duty belt worn by the public safety officer while seated, does not impede entrance or exit of the public safety officer into/out of the vehicle 100 and the like. Electronics, wiring and the like may be received in the compartment 224 of the console 220. The example console 220 includes a first opening 221, a second opening 222 and a third opening 223. Faceplates (not shown in FIGS. 2B-2D; see FIG. 2A) may be received in the openings 221, 222, 223 to provide interfaces for control of various systems, components, accessories, equipment and the like of the vehicle 100. The example console 220 includes three openings 221, 222, 223, simply for purposes of discussion and illustration. The console 220 can include more, or fewer openings, sized and/or shaped and/or arranged differently based on the equipment and controls to be accommodated in the console 220.

The console 220 includes a mounting plate 227 provided on a mounting section 228 of the console (see FIG. 2D). A display device 229 may be mounted on the mounting plate 227. The display device 229 may be connected, and/or in communication with, a computing device that is not necessarily located together with the display. In some examples, the mounting section 228 may be oriented at an angle with respect to the sidewalls defining the compartment 224, with the mounting plate 227 mounted thereon being oriented at a corresponding angle with respect to the cover 225. The angle at which the mounting plate 227 is oriented may allow the display device 229 to be visible by a driver seated in the driver's seat 210 and/or a passenger seated in the passenger's seat 210. FIG. 2E provides a close in view of the console 220 prior to attachment of the mounting plate 227 to the mounting section 228. FIG. 2F provides a close in view of the mounting plate 227 attached to the mounting section 228 of the console 220. In some examples, the display device 229 may be integrated into the mounting plate 227 on the console 220, or may be integrated into the console itself, and connected to a computing device that is physically separated from the display device. In some examples, the display device 229 may detachably connectable in the mounting plate 227. In this example arrangement, the mounting plate 227 and console 220 may function as a docking station for the display device 229. In some examples, an input device such as the example keyboard 226 shown in FIG. 2C may be provided on the console 220. In some examples, the keyboard 226 may be mounted on mounting arm 236 that is retractable and/or rotatable relative to the console 220. Mounting in this manner may provide for access to the keyboard 226 by both a driver seated in the driver's seat 210 or a passenger seated in the passenger's seat 210. In some examples, the keyboard 226 is detachably connectable to the mounting arm of the console 220. In some examples, the keyboard 226 is integrally provided with the console 220.

In some examples, the console 220 may include a card reader 231 and/or connection to card reading functionality. In some examples, the card reader 231 is formed as a slot in a portion of the console 220. In some examples, the card reader 231 may be formed in other portions of the console 220 than shown in FIG. 2C, and/or in other portions of the front cabin area 200. In the example shown in FIG. 2C, the card reader 231 formed as a slot may allow a card to be inserted into the slot to provide corresponding functionality. In some examples, the card reader 231 may be a key card reader that provides for operation of the example vehicle 100 when the card is received in the slot of the card reader 231. In some examples, the card reader 231 may provide functionality instead of, or in addition to, vehicle operation.

In some examples, the display device 229 may include a connection port 232 for connection of an external device to the display device 229, such as, for example, a computing device such as a laptop computer, a mobile phone, and other such external devices. In some examples, during operation of the example vehicle 100, the display device 229 may display information related to the operation of the example vehicle. In some examples, connection of an external device to the display device 229 via the connection port 232 may trigger a change in an output mode of the display device 229. For example, when an external device is connected to the display device 229 via the connection port 232, the display device 229 may switch, from displaying information related to operation of the vehicle 100, to displaying information provided via the external device. In some examples, this type of change in output mode of the display device 229 may be controlled via a control switch provided in the front cabin area 200, such as, for example, a control panel provided in a headliner of the interior cabin, in the console 220, on the dashboard, and the like.

In some examples, the vehicle 100 may be in operation while the display device 229 is outputting information provided by the external device, rather than information related to the operation of the vehicle 100. In some situations, the operator of the vehicle 100 and/or an occupant in the passenger's seat may still need at least some of the information related to the operation of the vehicle 100, which, in this mode of operation is no longer displayed by the display device 229. Accordingly, in some examples, an auxiliary display device may be provided in the front cabin area 200, to display information related to the operation of the vehicle 100. In some examples, the information displayed by the auxiliary display device may include a subset of the information related to the operation of the vehicle 100 that would otherwise be displayed by the display device 229. In some examples, the information displayed by the auxiliary display device may include, for example, vehicle speed, turn signals, gear selection, headlight activation, door ajar, parking display, vehicle braking actuation/hold, and other such information. In some examples, the auxiliary display may be positioned so as to be visible to an operator of the vehicle 100, for example, at a position on the dashboard within the field of view of the operator of the vehicle 100. In some examples, the auxiliary display device may be mounted on a dashboard cover assembly 230 mounted on the dashboard, to be described below with respect to FIG. 2G.

FIG. 2G is a perspective view of an example dashboard cover assembly 230, in accordance with implementations described herein. The dashboard cover assembly 230 may be mounted on, or installed on the dashboard in the front cabin area 200. The dashboard cover assembly 230 may provide for the mounting of equipment and/or accessories including, for example, camera systems, mobile phone systems, printers, radar antennae, radar counters, and other such equipment. In some examples, the dashboard cover assembly 230 may provide for the mounting of a secondary display system. The secondary display system may augment existing display systems included in the example vehicle 100 and/or other auxiliary display systems otherwise mounted in the example vehicle 100. The dashboard cover assembly 230 may provide for routing of equipment wiring, so that wiring does not interfere with access to equipment, entry into/egress from the example vehicle 100, and the like.

FIGS. 3A-3H(3) illustrate features of the rear cabin area 300 of the example vehicle 100. As shown in FIG. 3A, a rear seating area in the rear cabin area 300 includes a seat base 310 coupled to a floor 305 of the vehicle 100, and a seat back 320 coupled to the seat base 310. FIG. 3B illustrates the rear cabin area 300 prior to installation of the seat base 310 and seat back 320. As shown in FIG. 3B, a support flange 318 extends upward from the floor 305. At least one first coupling device 312 and at least one second coupling device 314 are provided on the flange 318, for coupling the seat base 310 to the floor 305 of the vehicle 100 via the flange 318. In the example shown in FIG. 3B, a compartment 315 is defined in an area behind the flange 318, and under the seat base 310 when the seat base 310 is coupled to the flange 318/floor 305. In an example in which the vehicle 100 is an electric vehicle, or a hybrid-electric vehicle, or a hybrid vehicle, a battery may be received in the compartment 315, as shown in FIG. 3B. As shown in FIG. 3C, in this example, the one or more second coupling device(s) 314 includes a slot formed in one of the flange 318 or the seat base 310 and a pin formed in the other of the flange 318 or the seat base 310, to guide a positioning of the seat base 310 relative to the flange 318, and to maintain a lateral position of the seat base 310 in the rear cabin area 300. In this example, the one or more first coupling device(s) 312 includes a bolt that extends through the seat base 310 and into the flange 318, to secure the seat base 310 to the flange 318/floor 305. One or more third coupling device(s) 316 may secure a rear end portion of the seat base 310 to a portion of a support frame of the vehicle 100. For example, one or more of the third coupling device(s) 316 may include a bolt extending through a seating portion of the seat base 310 and into an existing mounting point in the frame of the vehicle 100, as shown in FIG. 3A. One or more of the third coupling device(s) 316 may include a bolt extending through the rear portion of the seat base 310 and through a portion of the frame bordering the cargo area 400, to be secured by a nut, as shown in FIG. 3D.

Once the seat base 310 is positioned and secured as described above, the seat base 310 may also define a cover for the compartment 315 in which, in this example, a battery is received. The seat base 310 may be made of a material that is strong enough to withstand the weight of one or more passengers in the rear cabin area 300, seated on the seat base 310, without any type of support structure that would otherwise limit the volume, or capacity, or area available in the compartment 315 to accommodate the battery. That is, as shown in FIG. 3E, a rigidity of the material of the seat base 310 may be great enough so that the seat base 310 maintains its structural integrity and does not deform, even under full load, as such deflection would otherwise damage the battery received in the compartment 315. In this example, this is achieved without the use of support structure (support beams, members, and the like) under the seat base 310 and extending into the compartment 315 that would otherwise limit the space available to accommodate the battery. In some examples, the seat base 310 may be made of an aluminum material having a thickness great enough to provide the desired structural support and rigidity.

With the seat base 310 installed as described above, the seat back 320 may be coupled in place. As shown in FIG. 3F, a lower ledge 322 of the seat back 320 may be coupled to a corresponding surface of the seat base 310 by, for example, one or more fasteners extending through the lower ledge 322, through the corresponding portion of the seat base 310, and into a corresponding mounting point defined in the frame of the vehicle 100. An upper ledge 324 of the seat back 320 may be coupled to corresponding brackets 410 in the cargo area 400 by, for example, one or more fasteners. The seat back 320 may be made of a material that is strong enough to withstand the weight and/or forces imparted by one or more passengers in the rear cabin area 300, without any type of additional support structure, such that the seat back 320 maintains its structural integrity and does not deform, even under full load. In some examples, the seat back 320 may be made of an aluminum material having a thickness great enough to provide the desired structural support and rigidity.

In some examples, one or more stanchions 329 may be provided on the upper ledge 324 of the seat back 320. First end portions of seat belt(s) may be fixed to the one or more stanchions 329. Second end portions of the seat belt(s) may be coupled to the corresponding door. In a vehicle equipped for use in a public safety application, such as a police vehicle, this may allow for a passenger seated in the rear cabin area 300 to be belted in the rear cabin area 300 as the door is closed, without further intervention by the public safety officer.

FIG. 3G(1) is a top view, FIG. 3G(2) is a front view, and FIG. 3G(3) is a side view of the seat base 310. FIG. 3H(1) is a top view, FIG. 3H(2) is a front view, and FIG. 3H(3) is a side view of the seat back 320.

FIGS. 4A-4D illustrate features of the cargo area 400 of the example vehicle 100. As shown in FIGS. 4A and 4B, a first cargo panel 422 and a second cargo panel 424 are secured to a cargo area frame 430 by one or more coupling devices 426. FIG. 4C is a perspective view of the cargo area frame 430. In some examples, the second cargo panel 424, or a portion of the second cargo panel 424, may be movably coupled to the corresponding portion of the cargo area frame 430, to provide access to a storage compartment 435 below the second cargo panel 424. For example, the second cargo panel 424 may include an access panel, or a door, that is pivotable or rotatable relative to the remainder of the second cargo panel 424 to provide access to the storage compartment 435, and to securely enclose the storage compartment 435 when not in use/when access to the storage compartment 435 is not required. FIG.

As described above, a first bracket 410A is secured at a first lateral side of the cargo area 400, and a second bracket 410B is secured at a second lateral side of the cargo area 400. The brackets 410 (410A, 410B) may have a somewhat Z shape, as shown in FIG. 4D, including a first flange 411, a second flange 412, and a cross member 413 extending between the first flange 411 and the second flange 412. The first flange 411 is secured by one or more of the coupling devices 426, each extending through the first flange 411, through the second cargo panel 424, and into a corresponding mounting point in the cargo area frame 430. As shown in FIG. 4D, the upper ledge 324 of the seat back 320 is positioned between the second flange 412 and a coupling portion 521 of a divider panel 520 separating the rear cabin area 300 from the cargo area 400. One or more of the coupling devices 316 extends through the coupling portion 521 of the divider panel 520, through the upper ledge 324 of the seat back 320, and through the second flange 412 of the bracket 410, to secure the seat back 320 and the divider panel 520. The secure mounting of the brackets 410 (in particular, the first flanges 411 of the brackets 410) into corresponding mounting points in the cargo area frame 430 provides a secure base for the coupling and mounting of the seat back 320 and the divider panel 520.

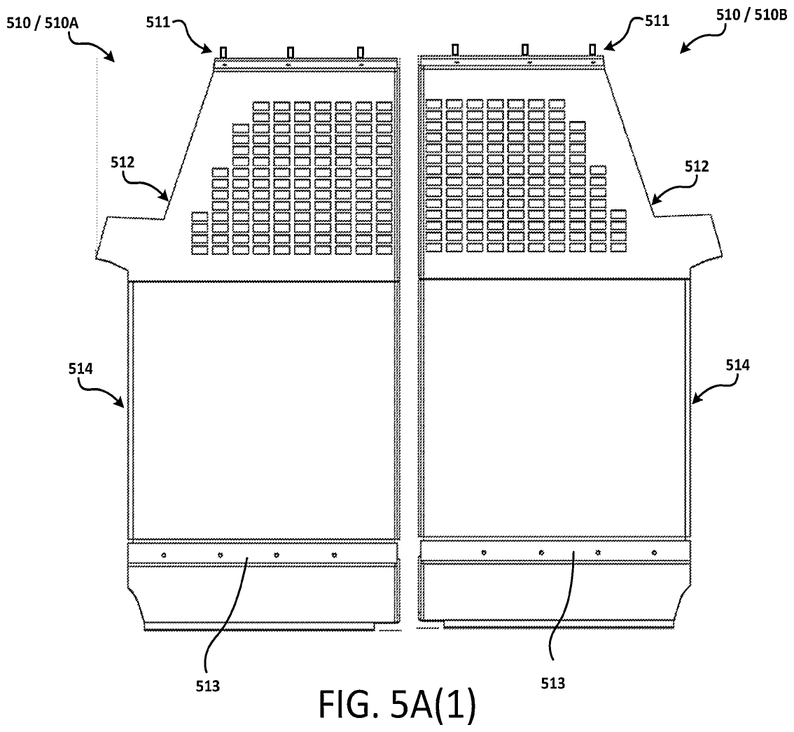

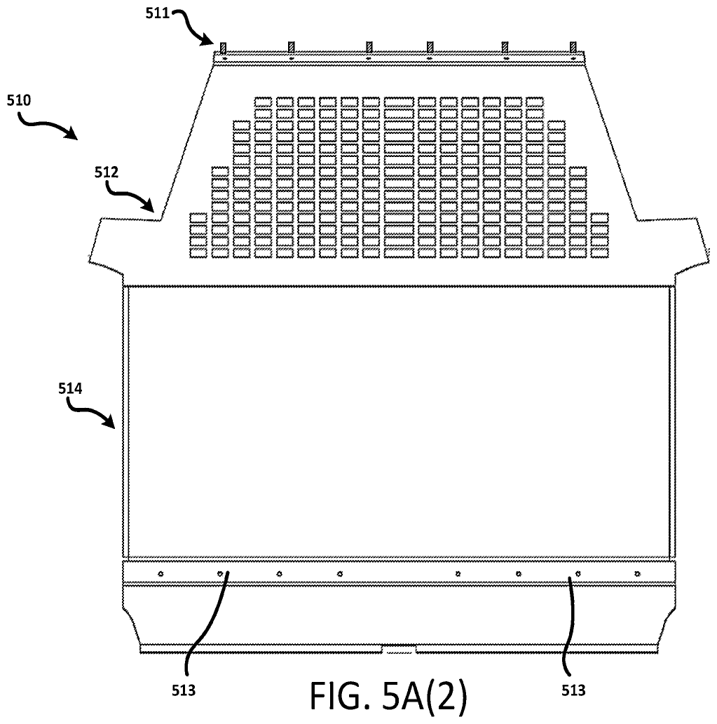

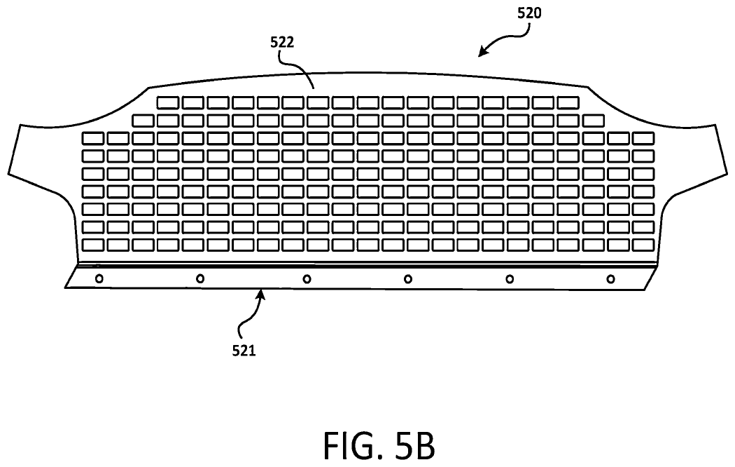

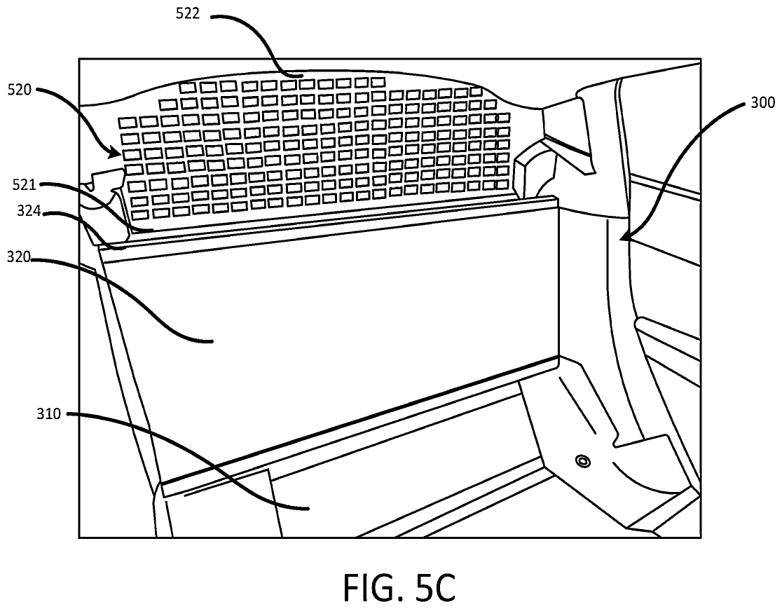

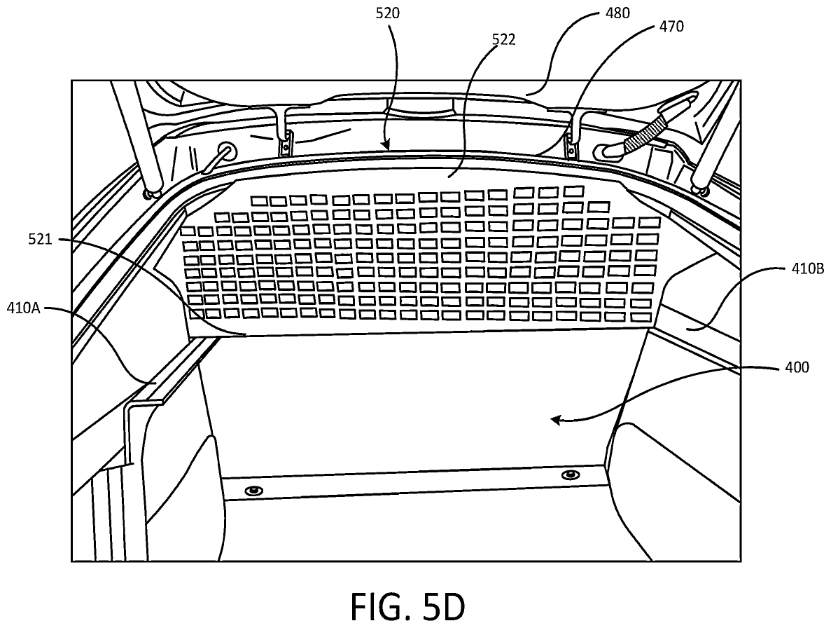

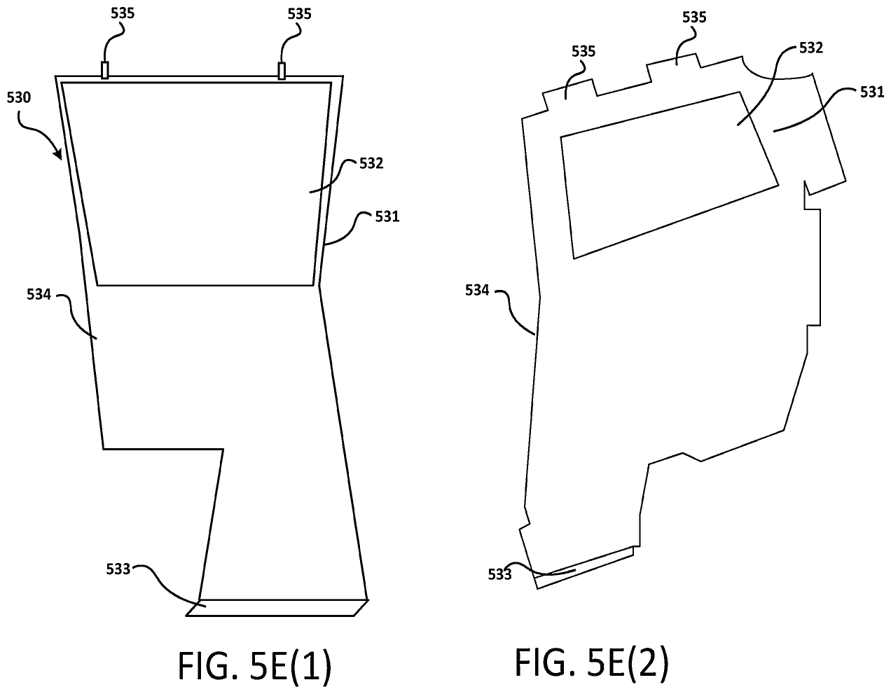

FIGS. 5A(1)-5E(2) illustrate divider panels that provide for separation of the first cabin area 200, the second cabin area 300 and the cargo area 400. In particular, a first divider panel 510 separates the rear cabin area 300 from the front cabin area 200, and a second divider panel 520 separates the rear cabin area 300 from the cargo area 400. In a situation in which the example vehicle 100 is equipped for use as a public safety vehicle, such as a police vehicle, the first divider panel 510 restricts access to the front cabin area 200 by a passenger in the rear cabin area 300, and the second divider panel 520 restricts access to the cargo area 400 by a passenger in the rear cabin area 300. A third divider panel 530 can be installed in the rear cabin area 300, to divide the rear cabin area 300 into two separate areas, and to restrict access between the two separate areas. The two separate areas may include, for example, various combinations of seating area(s), an equipment storage area, a canine transport area, and the like.

FIG. 5A(1) is a plan view in which the example first divider panel 510 includes a first panel section 510A and a second panel section 510B. FIG. 5A(2) is a plan view in which the first divider panel 510 is formed as a single panel. As shown in FIGS. 5A(1) and 5A(2), the first divider panel 510 (including both the first divider panel 510 including the first and second panel sections 510A, 510B and the first divider panel 510 formed as a single panel) may include an upper panel portion 512 and a lower panel portion 514 coupled to the upper panel portion 512. The upper panel portion 512 may be made of a material that provides for visibility through the upper panel portion 512, but that maintains secure separation between the rear cabin area 300 and the front cabin area 200. In some examples, the first divider panel 510 may include one or more coupling devices 511 at an upper end portion of the upper panel portion 512. The one or more coupling devices 511 may include, for example, a plurality of protrusions, a plurality of fasteners, and/or a combination thereof, that may be inserted into corresponding mounting points in the roof system 120 of the example vehicle 100, to secure the upper portion of the first divider panel 510 in the vehicle 100. In some examples, the first divider panel 510 may include one or more coupling devices 513 at a lower end portion of the lower panel portion 514 of the first divider panel 510. The one or more coupling devices 513 may provide for the coupling of the lower portion of the first divider panel 510 to the floor 305 and/or to support rails of the front seats 210. More details related to the configuration of the first divider panel 510 and the installation and/or removal of the first divider panel 510 can be found in the related U.S. application Ser. No. 18/057,309, filed on Nov. 21, 2022, entitled “Divider Panel System for Vehicle.”

FIG. 5B is a front view of the second divider panel 520, prior to installation in the vehicle 100. FIG. 5C is a view of the second divider panel 520 installed in the vehicle 100, taken from the rear cabin area 300. FIG. 5D is a view of the second divider panel 520 installed in the vehicle 100, taken from the cargo area 400. In the example arrangement shown in FIGS. 5B-5D, the second divider panel 520 includes a first coupling portion 521 at a lower portion of the second divider panel 520, and a second coupling portion 522 at an upper portion of the second divider panel 520. As described above, the first coupling portion 521 may be secured to the first and second brackets 410A, 410B, and to the upper ledge 324 of the seat back 320 to secure the lower portion of the second divider panel 520 between the rear cabin area 300 and the cargo area 400. The second coupling portion 522 may be secured between corresponding portions of a peripheral frame 470 of the cargo area 400 and a door 480 of the cargo area 400 with the door 480 in a closed position relative to the peripheral frame 470 of the cargo area 400. This may secure the upper portion of the second divider panel 520 between the rear cabin area 300 and the cargo area 400. More details related to the configuration of the second divider panel 520 and the installation and/or removal of the second divider panel 520 can be found in the related U.S. application Ser. No. 18/057,309, filed on Nov. 21, 2022, entitled “Divider Panel System for Vehicle.

As shown in FIGS. 5E(1) and 5E(2), the third divider panel 530 may include an upper panel portion 532 and a lower panel portion 534 coupled to the upper panel portion 532. The third divider panel 530 can be installed in the rear cabin area 300 to separate the rear cabin area 300 into two separate areas. The third divider panel 530 includes a first end portion 531 that is positioned against, or proximate, the first divider panel 510, and a second end portion 534 that is positioned against, or proximate, the second divider panel 520 and the seat back 520. One or more first coupling portions 535 at an upper end portion of the third divider panel 530 may be coupled to the roof system 120 of the example vehicle 100, to secure the upper portion of the third divider panel 530 in the vehicle 100. In the example shown in FIG. 5E(1), the first coupling portion(s) 535 are formed as protrusions that can be inserted into corresponding mounting points in the roof system 120. In the example shown in FIG. 5E(2), the first coupling portions 535 are formed as tabs, including openings through which fasteners can be inserted to couple the upper end portion of the third divider panel 520 to the roof system 120. A second coupling portion 533 at a lower end portion of the third divider panel 530 may be coupled, for example, bolted to the floor 305 of the vehicle 100 to secure the lower portion of the third divider panel 530 in the vehicle 100. In this manner, the third divider panel 530, together with the first divider panel 510 and/or the second divider panel 520, may define securely separated areas within the rear cabin area 300 of the vehicle 100. More details related to the configuration of the third divider panel 530 and the installation and/or removal of the third divider panel 530 can be found in the related U.S. application Ser. No. 18/057,309, filed on Nov. 21, 2022, entitled “Divider Panel System for Vehicle.”

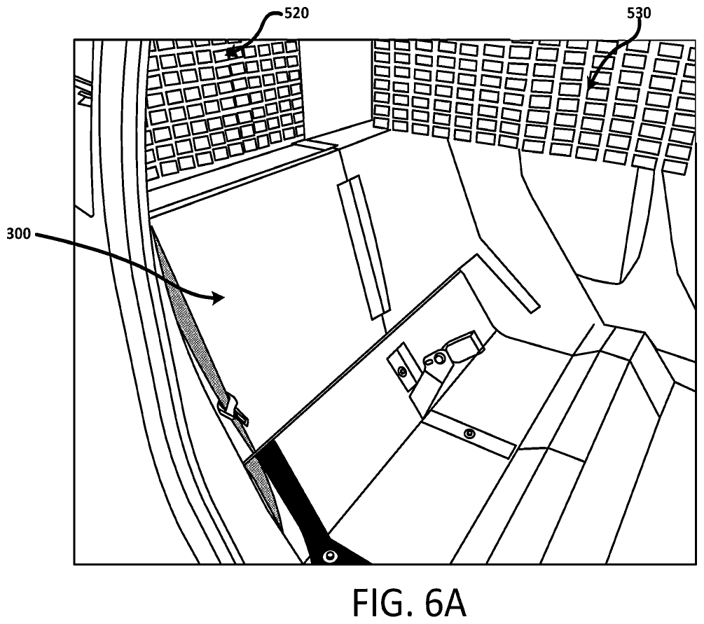

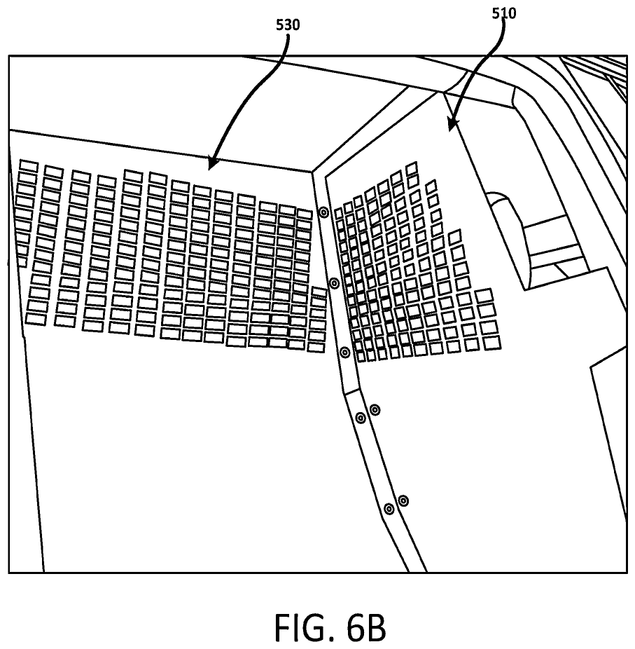

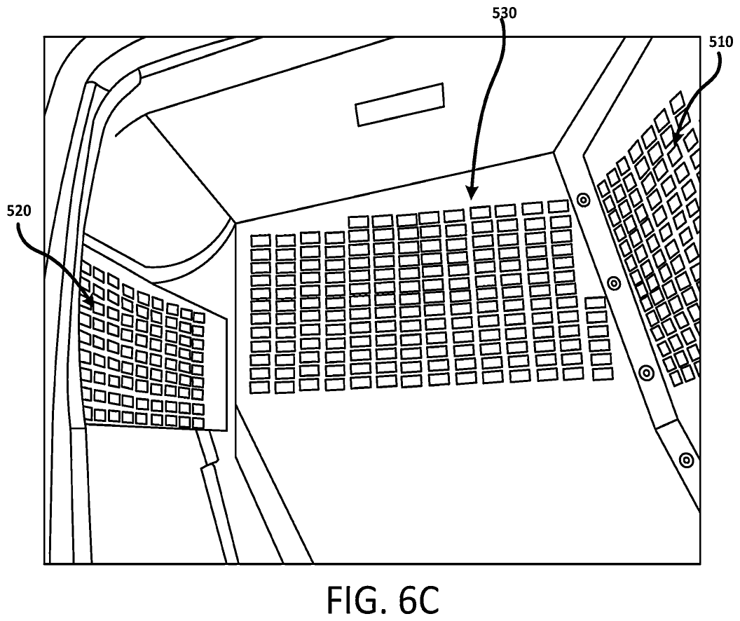

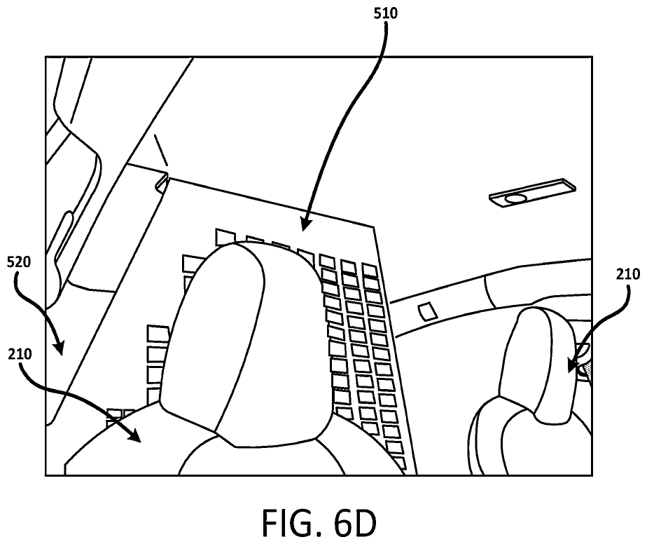

Additional interior views of the example vehicle are provided in FIGS. 6A-6D.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A vehicle, comprising:
a body defining an interior cabin including a front cabin area, a rear cabin area and a cargo area;
a roof system coupled to the body, the roof system including a roof panel including a plurality of mounting points configured to provide for the mounting of auxiliary equipment to the roof panel;
a first divider panel separating the rear cabin area from the front cabin area;
a second divider panel separating the rear cabin area from the cargo area; and
a console provided in the front cabin area, the console including one or more interface devices for controlling auxiliary equipment mounted on the vehicle or in the interior cabin.

2. The vehicle of claim 1, further comprising a rear seat installed in the rear cabin area, including:
a seat base having a first portion thereof coupled to a floor of the vehicle and a second portion thereof coupled to a frame portion of the vehicle;
a seat back having a first portion thereof coupled to the second portion of the seat base and to the frame portion of the vehicle, and a second portion thereof coupled to a cargo area bracket system.

3. The vehicle of claim 2, further comprising:
at least one first coupling device and at least one second coupling device coupling the seat base to a flange extending upward from a floor portion of the rear cabin area.

4. The vehicle of claim 3, wherein
the at least one first coupling device comprises at least one fastener extending through a portion of the seat base and a corresponding portion of the flange to secure a position of the seat base relative to the floor portion; and
the at least one second coupling device comprises at least one pin formed on the flange, and at least one corresponding slot formed in a corresponding portion of the seat base to guide a positioning of the seat base relative to the flange, and to maintain a lateral position of the seat base in the rear cabin area.

5. The vehicle of claim 2, wherein the seat base is made of a single sheet of metal material, including one or more bent portions to define a contour of the seat base.

6. The vehicle of claim 2, wherein the seat back is made of a single sheet of metal material, including one or more bent portions to define a contour of the seat back.

7. The vehicle of claim 2, further comprising a compartment defined between the seat base and a floor portion of the vehicle, wherein the compartment is configured to receive a battery therein.

8. The vehicle of claim 2, wherein the seat base and the seat back are made of an aluminum material.

9. The vehicle of claim 2, wherein the cargo area bracket system includes:
a first bracket at a first lateral side of the cargo area; and
a second bracket at a second lateral side of the cargo area.

10. The vehicle of claim 9, wherein
a first lateral end portion of the second portion of the seat back is coupled between the first bracket and a coupling portion of the second divider panel; and
a second lateral end portion of the second portion of the seat back is coupled between the second bracket and the coupling portion of the second divider panel.

11. The vehicle of claim 9, wherein the first bracket and the second bracket each include:
a first flange coupled to one or more mounting points defined in a cargo frame of the cargo area;
a second flange coupled to an upper end portion of the seat back and to a coupling portion of the second divider panel; and
a cross member extending between the first flange and the second flange.

12. The vehicle of claim 11, wherein
a first lateral end portion of the second portion of the seat back is positioned between the second flange of the first bracket and a coupling portion of the second divider panel, with a first fastener extending through the coupling portion of the second divider panel, the first lateral end portion of the second portion of the seat back, and the second flange of the first bracket; and
a second lateral end portion of the second portion of the seat back is positioned between the second flange of the second bracket and the coupling portion of the second divider panel, with a second fastener extending through the coupling portion of the second divider panel, the second lateral end portion of the second portion of the seat back, and the second flange of the second bracket, to secure the seat back to the frame portion of the vehicle.

13. The vehicle of claim 1, wherein the console includes a mounting portion including a mounting plate configured for detachable mounting of a display device.

14. The vehicle of claim 13, wherein the mounting plate is oriented at an angle with respect to the console such that a display device mounted thereon is visible by a user seated in a driver's seat of the front cabin area or a user seated in a passenger's seat of the front cabin area.

15. The vehicle of claim 13, wherein the console includes a mounting arm configured for movable mounting of an input device such that the input device is accessible by a user seated in a driver's seat of the front cabin area or a user seated in a passenger's seat of the front cabin area.

16. The vehicle of claim 15, wherein the display device and the input device are operably coupled to a computing device that is remote from the console.

17. The vehicle of claim 1, further comprising:
at least one bumper bracket coupled to a front frame portion of the vehicle; and
a push bumper positioned at a front cowling of the vehicle and coupled to the front frame portion of the vehicle by the at least one bumper bracket.

18. The vehicle of claim 17, wherein the push bumper includes at least one installation point for relocation of at least one optical sensor from the front cowling to the push bumper positioned at the front cowling.
